(19) United States
(12) Patent Application Publication
(10) Pub. No.: US 2009/0130240 A1
(43) Pub. Date: May 21, 2009

(54) DEVICE FOR MAKING CANDY, PARTICULARLY LOLLIPOPS

(75) Inventor: Johannes Hendricus Fransiscus Van Hoof, Budel (NL)

Correspondence Address: FOLEY & LARDNER LLP, 777 EAST WISCONSIN AVENUE, MILWAUKEE, WI, 53202-5306, US

(73) Assignee: CFS WEERT B.V., Weert (NL)

(21) Appl. No.: 11/719,723

(22) PCT Filed: Nov. 21, 2005
(86) PCT No.: PCT/NL2005/000805

§ 371 Date: Jan. 23, 2009

(30) Foreign Application Priority Data
Nov. 19, 2005 (NL) 1027556

(51) Int. Cl. B05D 5/08

(52) U.S. Cl. 425/107

(57) ABSTRACT

Device for manufacturing candy, particularly lollipops, comprising a series of mould sets driven so as to circulate, wherein the series of mould sets comprise a series of lower moulds and a series of upper moulds, wherein the lower moulds and the upper moulds are mutually movable between a position abutting each other, in which a mould in question is closed, and an open position, in which the mould is open and candy material can be supplied thereto, as well as means arranged on the device so as to be substantially stationary with respect to the circulating series of moulds for delivering one or more jets of pressurised fluid to both mould members for treatment of at least a part of their inner surface.

The invention relates to a device for making candy, particularly lollipops.

Such devices are used for making candy, such as lollipops, from candy material, particularly confectionery. The candy material may or may not be supplied in strands to a series of candy mould sets, which are for instance arranged on a drum rotating about a horizontal axis.

The candy mould sets usually consist of a relatively stationary lower mould, in which the candy material is received, and an upper mould, which can subsequently be closed onto the lower mould. In the closed mould the material is subsequently pressed on by a stamp provided on a reciprocally movable stamp rod that is part of the mould set in question, during which process the upper mould is kept pressed onto the lower mould. In case lollipops are made, a stick may simultaneously be inserted.

After the candy has been formed the moulds can be opened to take out the candy in question and transfer it to a next process, for instance packaging in a foil sheet.

After a while such a device needs to be cleaned. The usually sugar-containing material has an aggressive effect on the parts of the device. Movable connections between parts may as a result become less smooth or even jam, as a result of which the moulds no longer close properly. Material caked to the moulds may also be an impediment in fully closing the moulds.

After a period of use a candy-forming device is usually moved to a separate purpose-equipped washing location, in order to be hosed down with water. The device is then returned to the production location. Hosing down is a dirty job. Often the device is not sufficiently cleaned in this way, as a result of which a contamination causing failure occurs sooner in the device.

Not only does the existing method cost extra space (the washing location), the necessary transportation actions and the washing actions as well as drying also require time.

From U.S. Pat. No. 4,413,461 a device for making frozen candy on sticks is known, comprising a series of moulds that are positioned parallel and adjacent to each other on a straight holder and each comprise two mould members. The mould members are arranged on little rods that are hinged to the (joint) holder. The mould members are movable towards and away from each other about the hinges of the little rods. For the purpose of cleaning the inside of the mould members, the mould members are each provided with ducts for discharging cleaning liquid to the opposite mould member of the mould in question.

Such a cleaning system for parted moulds due to the ducts requires complex and as a result expensive mould members. Cleaning liquid and/or candy residue may be left behind in the ducts. In order to prevent the latter, it is suggested in this document to place a resilient diaphragm in the mould members, which renders the moulds even more complex and which may for that matter hinder the cleaning process.

It is an object of the invention to provide a device of the type mentioned in the preamble, which is easier to clean and/or maintain.

It is an object of the invention to provide a device of the type mentioned in the preamble, which can reliably and efficiently be cleaned and/or maintained.

From one aspect the invention provides a device for manufacturing candy, particularly lollipops, comprising a series of mould sets driven so as to circulate, wherein the series of mould sets comprise a series of lower moulds and a series of upper moulds, wherein the lower moulds and the upper moulds are mutually movable between a position abutting each other, in which the mould in question is closed, and an open position, in which the mould is open and candy material can be supplied thereto, as well as means arranged on the device so as to be substantially stationary with respect to the circulating series of moulds for delivering one or more pressurised jets of fluid to both mould members for treatment of at least a part of their surface.

Due to positioning the fluid delivery means separate from the parted moulds, both mould members can remain simple in design, in a standard embodiment, and yet be cleaned. The fluid delivery means can also be simple, as moving connections for them are not necessary and they can be positioned for the treatment of all moulds during their passing by the fluid delivery means.

By opening the moulds by movement of both mould members in order to space them apart, room is created for a stationary deliverer for treatment of the inner surface. The treated surface may thus comprise at least a part of the inner surface, but particularly the entire (mould) inner surface of both mould members. The fluid delivery means can be positioned between the local circulating movement paths of both mould members, as a result of which the delivery of fluid can take place as oriented and direct as possible, at/on both mould members. As a result an optimal cleaning of the inner surfaces is achieved, as a result of which the flawlessness of the candy made is maintained during the entire manufacturing process of a batch, which is of great importance for so-called 3D-candy.

In an embodiment thereof the lower moulds are arranged on a circulating carrier and the upper moulds are hinged thereto at the location of hinges for a movement between a position abutting the lower moulds, in which a mould in question is closed, and an open position, in which the mould is open and material can be supplied thereto, wherein the fluid delivery means are positioned in the notional (hinging) path of the movement of the upper moulds. In other words the delivery means may be situated at a location which is situated within the rotary path of the upper moulds, of the opening and closing motion thereof, yet when considered in circulation path are spaced apart therefrom, as they would otherwise interfere with said opening/closing motion.

It is noted that from British patent specification 751.530 a device is known for making candy, which comprises a circulating series of radially outward open moulds, which have been arranged on a drum and each have a bottom formed by a radially retractable/extendable piston. In process direction after discharging the formed candy, a water sprayer, an air blower and a scraper, are consecutively positioned at the outside of the path of the moulds. The water sprayer and air lower are oriented radially to the inside.

The moulds may comprises a mould stamp that is movable after closing the mould members, which mould stamp also defines the inner surface and then can be cleaned by the fluid delivery means.

The treated surface may comprise at least a part of the outer surface of the mould sets.

In a first further development of the device according to the invention the delivery means comprise first spraying means for delivering pressurised liquid, particularly water. Water dissolves the candy material and it can be discharged with the water, for instance via a collection tray belonging to or placed near the device, which tray can be connected to a fixed discharge.

Preferably the device is further provided with means for heating the fluid, particularly liquid, as a result of which the candy material can be more effectively removed.

In a second further development of the device according to the invention the delivery means comprise second spraying means for delivering pressurised gas, particularly air. By means of compressed air grit can be blown away, which enhances a periodical cleaning—water being sprayed after that—. However, it is also possible while being continuously operative to treat the mould sets with compressed air, so that grit is continuously removed, almost immediately after its formation/deposit.

In a regularly occurring embodiment, particularly suitable for making lollipops, wherein the lower moulds are arranged on a circulating carrier and the upper moulds are hinged thereto at the location of hinges for a movement between a position abutting the lower moulds, in which a mould in question is closed, and an open position, in which the mould is open and candy material can be supplied thereto, at least one of the delivery means can be positioned for delivering one or more jets of fluid, particularly compressed air, to the hinge. In this way the hinge is efficiently freed from grit.

In a third further development of the device according to the invention the delivery means comprise third spraying means for delivering a lubricant. In this way it can be ensured that the moving parts of the mould sets remain moving smoothly, due to which failures are counteracted. Applying a lubricant may even take place during the moulding process, so that the necessary standstill time can be kept to a minimum.

In a further development of the embodiment having first spraying means the lower moulds may be arranged on a circulating carrier and the upper moulds are hinged thereto at the location of hinges for a movement between a position abutting the lower moulds, in which a mould in question is closed, and an open position, in which the mould is open and candy material can be supplied thereto, wherein at least one of the first spraying means is positioned for delivering one or more jets of pressurised fluid, particularly water, to the outside of the upper moulds. In that way the outside can be engaged smoothly in a failure-proof and even manner by the pressing means for keeping the moulds closed.

Preferably the delivery means in question is positioned in a track of the circulation of the mould sets where the moulds are closed.

In a further development of the embodiment having first spraying means, the lower moulds may be arranged on a circulating carrier and the upper moulds are hinged thereto at the location of hinges for a movement between a position abutting the lower moulds, in which a mould in question is closed, and an open position, in which the mould is open and candy material can be supplied thereto, wherein at least one of the first spraying means is positioned for delivering one more jets of pressurised fluid, particularly water, to the inside of the upper moulds and/or the inside of the lower moulds. In that way it is ensured that the mould surfaces that contact the candy material, at all times offer a space of a same shape to the candy material, as a result of which the quality and the shape of the candy, such as lollipops, can be constant and double candy, such as double lollipops, is prevented.

The effectiveness of said delivery means is enhanced when the delivery means in question is positioned in a track of the circulation of the mould sets where the moulds are opened.

In a further development of the embodiment having second spraying means, the lower moulds may be arranged on a circulating carrier and the upper moulds are hinged thereto at the location of hinges for a movement between a position abutting the lower moulds, in which a mould in question is closed, and an open position, in which the mould is open and candy material can be supplied thereto, wherein at least one of the second spraying means is positioned for delivering one or more jets of gas, particularly compressed air, to the hinge.

The effectiveness of this treatment is increased if the second spraying means is positioned in a track of the circulation of the mould sets where the moulds are closed and/or start opening.

In a further development of the embodiment having second spraying means, the lower moulds may be arranged on a circulating carrier and the upper moulds are hinged thereto at the location of hinges for a movement between a position abutting the lower moulds, in which a mould in question is closed, and an open position, in which the mould is open and candy material can be supplied thereto, wherein at least one of the second spraying means is positioned for delivering one or more jets of gas, particularly compressed air, to the inside of the upper moulds and/or the inside of the lower moulds. In that way it is ensured that the mould surfaces that contact the candy material, at all times offer a space of a same shape to the candy material, as a result of which the quality and the shape of the candy, such as lollipops, can be constant and double candy, such as double lollipops, is prevented.

The effectiveness of this treatment is further increased if the second spraying means is positioned in a track of the circulation of the mould sets where the moulds are open and/or start opening.

In a further development of the embodiment having third spraying means, the lower moulds may be arranged on a circulating carrier and the upper moulds are hinged thereto at the location of hinges for a movement between a position abutting the lower moulds, in which a mould in question is closed, and an open position, in which the mould is open and candy material can be supplied thereto, wherein at least one of the third spraying means is positioned for delivering lubricant to the hinge, particularly atomised, as a result of which a reliable movement at the location of the hinge is enhanced.

In a further development of the embodiment having third spraying means, each mould set may comprise a mould stamp, arranged on a stamp rod that is movable between an inactive position and a pressing position, wherein the stamp rod is guided in a guide, wherein at least one of the third spraying means is positioned for delivering lubricant to the stamp rod and/or its guide, particularly atomised, as a result of which a reliable movement of the mould stamp is enhanced.

The effectiveness thereof is increased if the third spraying means is positioned where the stamp rod is situated at least close to the inactive position.

In a manner known per se the mould sets may be arranged on a drum driven so as to circulate and having a horizontal axis of rotation.

In a further embodiment of the device according to the invention it is provided with means for setting the active time of the delivery means, so that a cleaning program adjusted to the actual need can be carried out, optionally pre-set.

The device according to the invention may furthermore advantageously be provided with means for setting a program for the sequence and duration of the activation of the delivery means, in which way an optimal cleaning and maintenance program can be set, optionally depending on the production process in question (speed, candy shape/size, type of candy material—with or without filling, such as gum—).

From a further aspect the invention provides a device for manufacturing candy, particularly lollipops, particularly as described above, comprising a drum driven so as to circulate about a drum centre line, the drum having a series of moulds on it, wherein the series of moulds comprise a series of lower moulds and a series of upper moulds, wherein the lower moulds and the upper moulds are movable with respect to each other between a position abutting the lower moulds, in which a mould in question is closed, and an open position, in which the mould is open and candy material can be supplied thereto at the location of a supply station or can be discharged therefrom at the location of a discharge station, further comprising means positioned stationary downstream from the discharge station in process direction, for engaging candy material in the lower mould and/or the upper mould with a force having a directional component that is situated in a plane containing the drum centre line.

In this way it is achieved that pieces of candy, such as of a lollipop, or even whole lollipop heads, that adhere more strongly to the moulds are not inadvertently left behind in the moulds, which would otherwise in a next production cycle result in for instance a double lollipop in the mould and having to stop the machine.

In a simple embodiment the engagement means comprise a first and/or second engagement member positioned for engaging the candy material with a force having a directional component that is parallel to the drum centre line.

In a further development thereof the lower moulds extend parallel to the drum centre line, between an inner end and an outer end, wherein the lower moulds and the upper moulds are hinged to each other at the location of respective hinges, wherein the hinge is situated at the side of the inner end, wherein the first engagement member is positioned for engaging the candy material from the outside. The first engagement member may comprise an obliquely inwardly oriented engagement edge, which preferably is straight in a view parallel to the drum centre line. The stuck candy material that is left behind is then easily, due to the rotation of the drum, moved in the mould and detached.

In a further development the lower moulds extend parallel to the drum centre line, between an inner end and an outer end, wherein the hinge is situated at the side of the inner end, wherein a stamp head is present at the inner end which stamp head is reciprocally movable in the mould, wherein the second engagement member is positioned for engaging the candy material from the inside, at the outside of the stamp head. Here as well the stuck candy material that is left behind is then easily, due to the rotation of the drum, moved in the mould and detached. Preferably the second engagement member is positioned for cutting into the candy material, at a distance from the stamp head, as a result of which no interference with the stamp head takes place and the candy material can be engaged properly at all times. In an advantageous embodiment the second engagement member comprises an obliquely outwardly oriented cutting edge, which preferably is part of a freely rotatable bearing-mounted disk.

In yet a further development means are provided for keeping the upper moulds open in a position oriented perpendicular to the drum centre line, wherein the engagement means comprise a third engagement member positioned for engaging the candy material with a force having a directional component that is perpendicular to the drum centre line, preferably towards the hinge. Candy material left in the aforementioned radially oriented upper moulds can thus also be reliably removed using the rotation of the drum. The third engagement member may—in a view parallel to the drum centre line—comprise an engagement edge which is obliquely oriented to the hinge, which engagement edge preferably is situated in a plane perpendicular to the drum centre line.

In a further development the engagement means are arranged on a holder, which is movable between an operative position and an inoperative position, in the latter of which the engagement means and the holder are situated outside of the profile of the drum including moulds, considered in a view parallel to the drum centre line. As a result the drum despite the presence of the engagement means, which have to extend into the path of the moulds, can still be removed from the frame of the device in order to be repaired or replaced.

The aspects and measures described and/or shown in the application can where possible also be used individually. Said individual aspects, such as the water sprayers for the outer surface, the water sprayers for the inner surface, the air sprayers for the outer surface, the air sprayers for the inner surface, the engagers for detaching the candy material from the various mould members, and other aspects may be the subject of divisional patent applications related thereto.

The invention will be elucidated on the basis of a number of exemplary embodiments shown in the attached drawings in which:

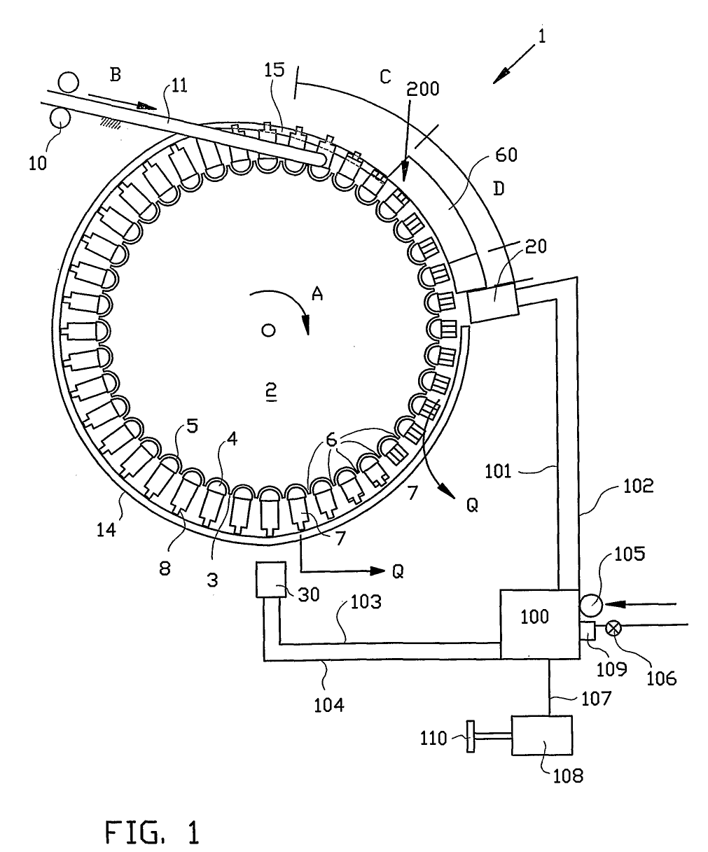

FIG. 1 shows a schematic front view of a machine for manufacturing lollipops according to the invention;

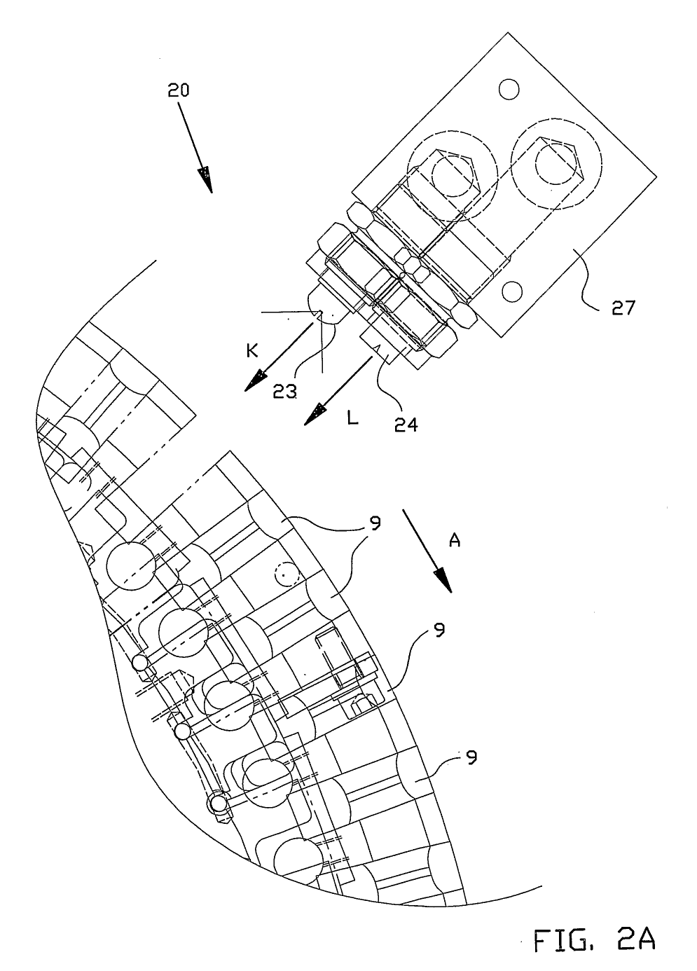

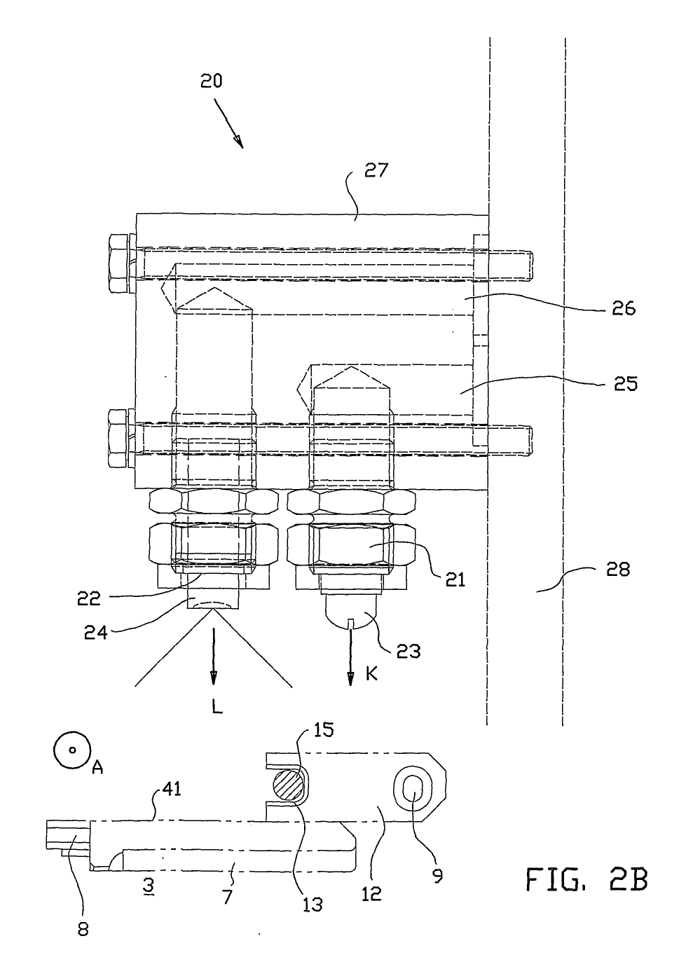

FIGS. 2A and 2B show schematic views of a first station for spraying the moulds of the lollipop machine of FIG. 1;

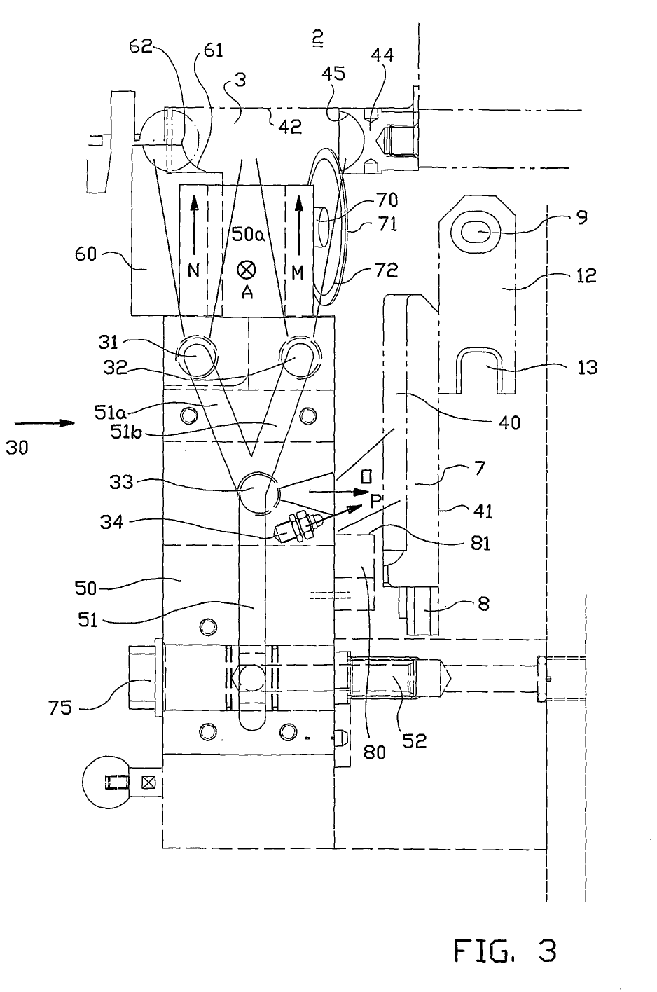

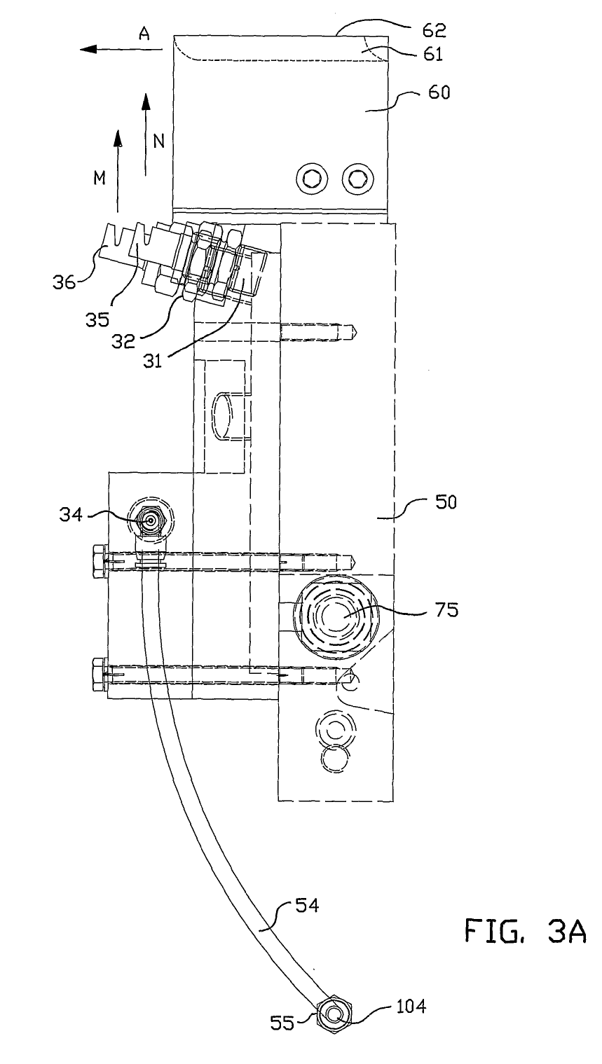

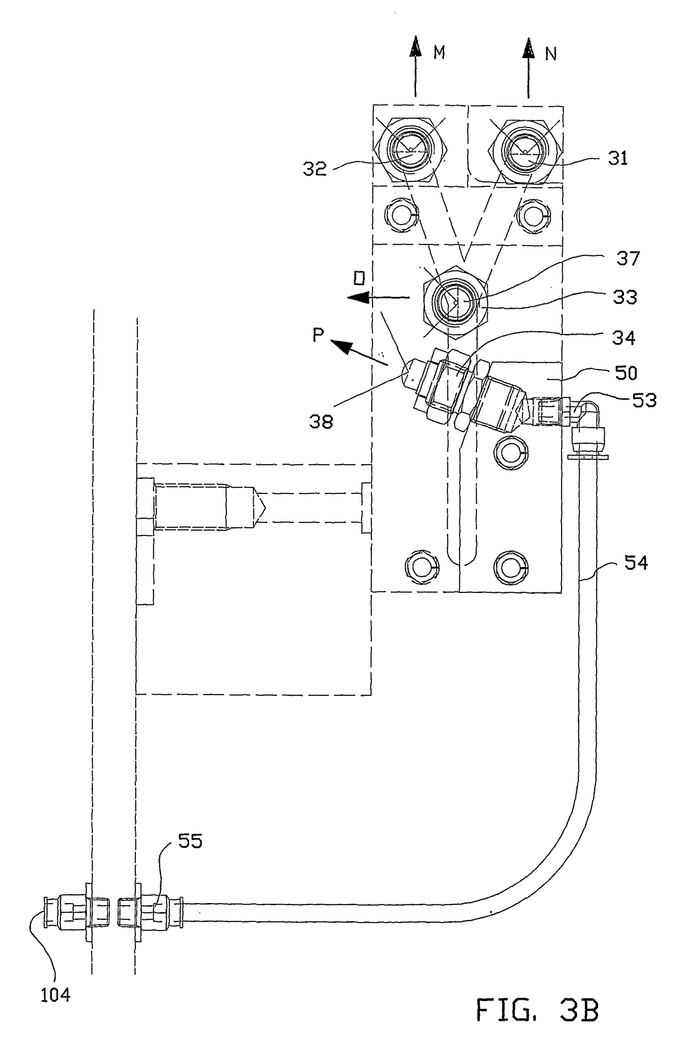

FIGS. 3, 3A and 3B show schematic views of a second station for spraying the moulds in the lollipop machine of FIG. 1;

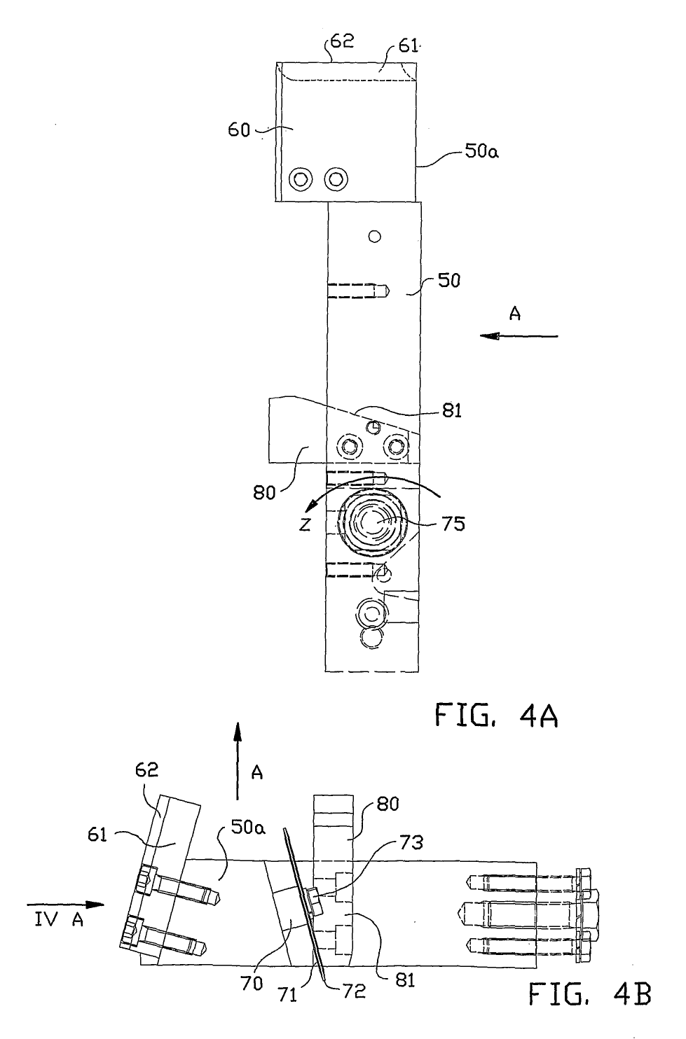

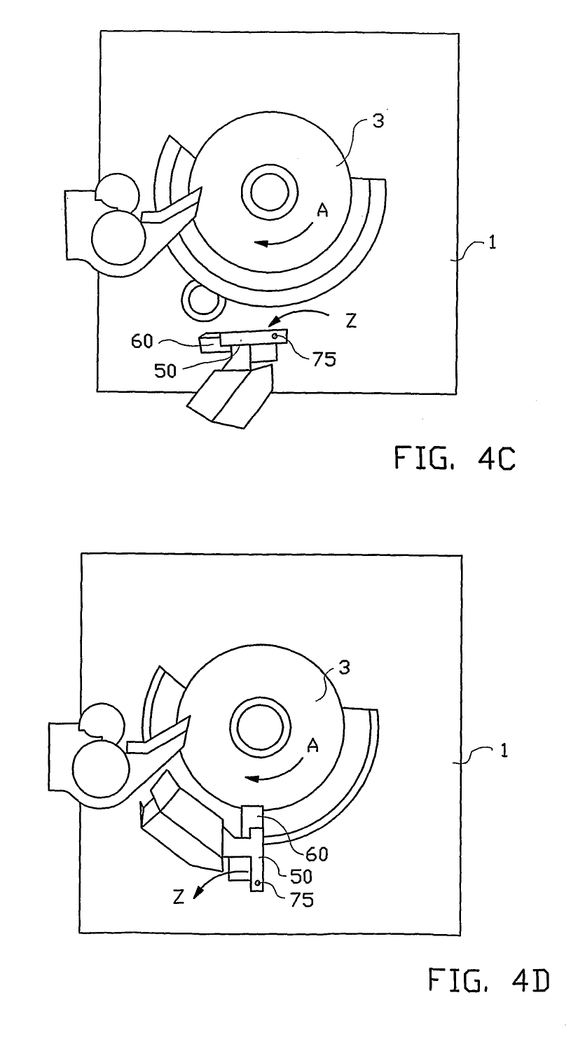

FIGS. 4A and 4B show a front view and a top view of the second station, without sprinklers;

FIGS. 4C and 4D show two front views with the second station in the operative and inoperative positions, respectively; and

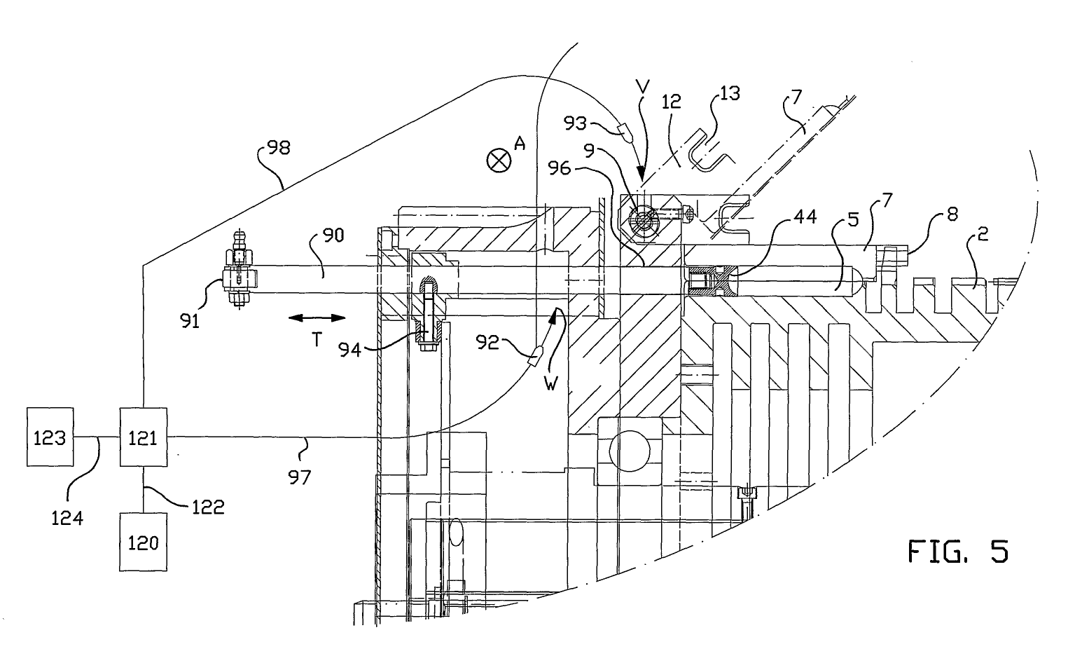

FIG. 5 shows a partial longitudinal section of the drum of the machine of FIG. 1, indicating the location of a third station for delivering lubricant.

The lollipop machine 1 shown in FIG. 1 comprises in manner known per se a drum 2 driven in the direction A, on the outer surface 3 of which among others a number of lollipop mould sets 4 are arranged. The lollipop mould sets 4 are substantially formed by lower moulds 5 that are fixed to the drum 2, and separated from each other by ribs 6. The lollipop mould sets 4 further comprise a mould stamp 44 having stamp axis 90 and roller 91 (FIG. 5). On the drum 2 upper moulds 7 are furthermore arranged, which upper moulds circulate along with the drum 2 yet which can hinge in radial planes, between an open position, wherein access is given to the lower moulds 5, and a closed position, wherein the moulding of lollipop material into lollipop heads takes place.

In this case the upper moulds 7 in circumferential direction are depicted equally positioned to the lower moulds 5, yet may also be staggered half a mould width to the lower moulds, also in a manner known per se. A strand supply 10 is furthermore shown for supplying a strand 11 of lollipop material in the direction B, wherein when closing the upper mould in question onto a related lower mould the leading end of the strand is each time cut into a lollipop head portion. This takes place in track C, in which the upper moulds 7 are closed.

As schematically shown in FIGS. 2B and 3 the upper moulds 7 are lid-shaped, having an outer surface 41 and an inner surface 40, facing the mould cavity. On the drum 2 there are mould stamps 44 (FIG. 3), that are in line with each lower moulds and which have a stamp surface 45. On the lid 7 a bracket 12 is attached which is provided with a recess 13 and a hinge 9, with which the lid 7 is hinged to the drum 2. At the side facing away from the hinges 9 the lid 7 is provided with a lip 8 which is able to fit into an accommodation space in the drum intended for that purpose in order to stabilise the lid 7 in circumferential direction. For engaging and retaining the lid 7 a stationary rod 14 is arranged along the circumference of the drum 2, which rod engages into recess 13. The rod 14 has an end portion 15 that runs obliquely towards the drum, so that lid 7 is thus urged into the closed position. Subsequently in track D the mould pressing takes place, in which the upper moulds 7 are kept pressed against the lower moulds 5 by a pressure block 60. In the track D, in a manner known per se, the mould stamps 44 are pressed inside the mould cavity in order to form the lollipop.

Immediately downstream from the pressure block 60 the first spray station 20 is positioned, further shown in FIGS. 2A and 2B.

Subsequently during continuous rotation of the drum 2 in the direction A the upper moulds 7, after urging the lip 8 slightly upward by means of a pilot edge (not shown) in order to exert an opening moment on the lids 7, the lids 7 are urged into the open position, rotating about the hinges 9, due to engagement of the rod 14 in the recess 13. The lollipops are usually discharged in the direction Q.

In the bottom track of the circulation of the drum 2, where the lids are fully open, the second spray station 30 is positioned, which station is further shown in the FIGS. 3 and 3A,B.

The moulds are subsequently rotated anticlockwise and upward, along with the rotation of the drum 2, wherein the open position of the upper moulds 7 is maintained by rod 14 that engages in the recess 13.

In the first spray station 20 a spray block 27 is fixed to the wall 28 of the device 1, wherein an air sprayer 21 and a water sprayer 22 (flat jet sprayers) have been arranged on the spray block 27. The air sprayer 21 has a nozzle 23 and the water sprayer 22 has a nozzle 24, from which compressed air and heated water is delivered in the directions K and L, respectively. Supply of air and water, respectively, takes place via passages 25, 26, that are connected to the pressure lines 101, 102 shown in FIG. 1. The water line 101 may in this case be connected to the mains.

The position of the air nozzle 23 is such that in an oriented manner it delivers compressed air in the direction K on the area of the hinge 9 and the upper mould 7. The water nozzle 24 is oriented at the upper surface 41 of the upper mould 7. The water nozzle 24 has been given such a shape that a flat fan is delivered, so that the upper surface 41 of the upper mould 7 is covered over nearly its full length. Due to rotation of the upper moulds 7 the latitudinal direction is also fully covered by the heated water.

With the compressed air delivered by the nozzle 23 grit residues are removed from the hinge area 9. The heated water from the water nozzle 24 ensures the detachment and removal of lollipop material stuck to the upper moulds 7. The air nozzle 23 may if so desired be continuously operated during the lollipop manufacturing process.

The second spray station 30 shown in the FIGS. 3, 3A,B comprises a spray block 50 that is fixedly positioned with device 1, and has connection 52 to a line for heated water, again connected to the mains as well, with passage 51 and branches 51a,b, that lead to water sprayers 31, 32. A third water sprayer 33 is also connected to passage 51.

In the block there is furthermore a connection 53 for a compressed air line 54, which via connection 55 is connected to a compressed air supply line 104 shown in FIG. 1. An air nozzle 34 is connected to the connection 53 and provided with a nozzle 38 delivering compressed air in the direction P, which direction has a component that is parallel to the drum axis.

The water sprayers 31, 32 and 33 are provided with nozzles 35, 36 and 37, respectively, which deliver water in the directions M, N and O, respectively (which direction O has a component that is parallel to the drum axis). In this case as well water is delivered in the shape of flat fans (flat jet sprayers), in order to achieve as large an effective length as possible, considered in the direction of the lower mould/upper mould 5/7. As can be seen in FIG. 3A the nozzles 35 and 36 are positioned in a staggered manner with respect to each other in rotation direction A, so that both fans of said nozzles do not interfere with each other.

The inner surface 40 of the upper mould 7 is covered by the nozzle 37 in order remove adhering lollipop material therefrom. The air nozzle 38 is also oriented at the inner surface 40 of the upper mould 7. The air jet is oriented slightly upward, as a result of which the inner surface of the lower mould 5 will also be covered in order to remove grit therefrom.

The water nozzles 35 and 36 are oriented at the inner surface 42 of the lower moulds 5 and, as regards the water nozzle 36, also at the stamp surface 45 of the stamp 44.

As can be seen in FIG. 3 the various nozzles are situated in an area which, if the upper mould 7 would be closed, is within the path of movement of the upper mould 7. The nozzles as a result extend as closely as possible to the surfaces to be treated, due to which the effectiveness is optimal.

After passing by the second station 30, the lower moulds 5 and the upper moulds 7 will have been cleaned and they will offer a clean surface to the leading end of the strand 11 of lollipop material that is supplied in the direction B.

After washing by means of the water sprayers, the air sprayers may be used for blowing the moulds dry.

In FIG. 1 it is schematically shown that the first station 20 is connected to a distribution station 100 via water line 101 and compressed air line 102. The second station 30 is connected to the distribution station 100 by means of water line 103 and compressed air line 104. A compressed air source 105 and a heating unit 109 are also part of the station 100, for the compressed air and the water, respectively, supplied via the water line 106 connected to the mains.

In the station 100 there are various valves for regulating the passage of compressed air and water that may or may not be heated to the lines 101-104. The station 100 is controlled via a line 107 by means of a programmable control unit 108 that can be set with operation panel 110.

The cleaning by means of the said spray stations 20 and 30 may take place at fixed times, for instance at the end of a working day, without strand supply.

Optionally cleaning can also take place while operative, with water and/or air. For instance once every hour compressed air can be delivered to the hinges, during a number of revolutions.

As the candy manufacturing device, such as a lollipop machine, is itself already provided with the delivery means for delivering pressurised fluid to the mould sets, the device need not be moved for carrying out cleaning and/or maintenance can take place more easily and more regularly. As a result time and space is saved on. The treatment of the device can be carried out as often as one wishes.

In FIGS. 4A and 4B the block 50 is shown depicted in the FIGS. 3, 3A and 3B as regards parts with which lollipop material that is left behind in the upper mould and/or lower mould can be removed. On the block 50 an elevation 50a is provided, on which, looking in the direction of rotation of the drum 2, on the left-hand side, that means the at side that is situated closest to the front side of the device 1, a scraping block 60 is provided which is provided with a concave curved surface 61 and an upper edge 62. The upper edge 62 is horizontal, and as can be seen in FIG. 4B, the surface 61 and the upper edge 62 are at an acute angle to the direction A. As can be seen in FIG. 3 the edge 62 extends up to the path of the ribs 6 between the lower moulds 5, so that lollipop material that is situated there in the lower moulds 5 and projects beyond the lower moulds, can be engaged. Due to the oblique position of the surface 61 and the edge 62 the lollipop mass is urged away from the front side of the device 1, as a result of which the adhering action with the lower mould surface 42 of the lower mould 5 is ended and the lollipop material is able to drop out downward. The concave shape of the surface 61 enhances the engagement of the (round) lollipop residue.

At the other side of the lower moulds 5, near the path of the stamps 44, a hub 70 is attached to the elevation 50a, to which hub by means of a part 73 a freely rotatable thin disk 71 is attached. The axis of rotation of the disk 71 is horizontal, yet is at an angle to the direction A, as shown in FIG. 4B, which angle corresponds with the one of edge 62, but opposite in that case.

As can also be seen in FIG. 3 the disk 71 with cutting edge 72 extends to the level of the path of the ribs 6 between the lower moulds 5, in order to engage lollipop material that has been left in the lower mould 5 in front of the stamp 44 and projects downwards therefrom, and due to the oblique position, to exert a force thereon oriented to the front side of the device 1, as a result of which said lollipop material will also be able to become detached from the mould surface 42 and optionally the surface 45 of the stamp 44 and drop out downward.

For the lollipop material that remains stuck to the inner surface 40 of the upper moulds 7, the block 50, at the side facing the machine, is provided with a scraping block 80 fixed thereto, which scraping block as can be seen in FIG. 4A, has an edge 81 rising in the direction A, which extends to close to the path of the upper moulds 7 in order to engage lollipop material that projects horizontally therefrom and exert an upward force thereon, so that said lollipop material becomes detached from the inner surface 40 of the upper moulds 7 and drops out downward.

In the FIGS. 4C and 4D it is schematically shown that the block 50, provided with the scraping means shown in FIGS. 4A and 4B and with the spraying means shown in FIG. 3, can be tilted (direction Z, see FIG. 4A) from the active position, in which in horizontal front view the block 50 is situated in front of the path of the lids 7 held vertically open by the rod 14, about axis 75 (rotation over 90 degrees) to a position in which said coinciding in projection is no longer present. In that case the drum 2, also called insert, with the upper moulds of the device 1 attached thereto, can be removed, after the rod 14 in front of it is removed. The block 50 can be locked in the active position.

In a partial longitudinal section of the drum 2, FIG. 5 schematically shows which parts the pressure station 200 (FIG. 1) for lubrication may comprise. The shown location 200 is in the track D, at the beginning thereof (FIG. 1), where the mould stamps 44 are moved in a direction to the front side of the device, in order to reduce the mould cavity formed between the lower moulds 5 and the upper moulds 7 and press on the lollipop material present in there. A stock of lubricant 123, which lubricant is allowed for foodstuffs, for instance oil Kluber 4uh1-32N, is connected with a compressed air source 121 via line 124. By means of control unit, in this case 120, but which may be part of the control unit 108 (FIG. 1), the compressed air source 121 is activated via line 122 for, with compressed air, delivering drops of lubricant from the stock 123, to, after selection, line 97 and/or line 98, which lead to a nozzle 92 for discharge of lubricant in the direction W to the stamp axis 90 on which the stamp head 44 is attached and/or to a nozzle 93, from which lubricant is delivered in the direction V to the hinge 9 for the upper moulds, respectively.

At the free end the stamp axis 90 is provided with a freely rotatable roller 91 that abuts a stationary cam track that is not shown, as a result of which the stamp axis 90 and thus the mould stamp 44 can be urged to the right (T) as considered in the drawing. In the shown position the mould stamp 44 is in its far right position. For retrieving the mould stamp 44 from the far right position (T), the stamp axis 90 is provided with a flight 94. The stamp axis 90 extends through a passage 96 in the drum 2, and the nozzle 72 is oriented such (W) that lubricant is delivered at the location of the opening of the passage 96, so that lubricant is directly taken along into the passage 96 on the outer surface of the stamp shaft 90 when it moves in the direction T to the right.

The nozzles 92 and 93 deliver an atomised lubricant/air mixture, wherein only a little lubricant is used. The delivery of the lubricant by nozzles 92 and 93 can be controlled such that this takes place continuously in a short period of time, until the entire circumference has been treated. This may be repeated for instance after one hour of operation time. The lubrication may also be carried out in register to the said spraying with water and air, particularly after a complete cleaning of the drum.

It is noted that where there is question in this application of means for delivering one or more jets of fluid, first, second, third spraying means and means for engaging candy material, also fluid jet delivery device, first, second, third sprayers and candy material engager, respectively, can be read.

1.-21. (canceled)

22. A device for manufacturing candy, comprising:
a series of mould sets configured to circulate, each mould set comprising a lower mould and an upper mould that are mutually moveable between a closed position wherein the mould set is closed and the upper mould abuts the lower mould, and an open position wherein the mould set is open; and
a fluid delivery mechanism for delivering one or more pressurized jets of fluid to a treated surface, the treated surface comprising at least a portion of the surfaces of both the upper mould and the lower mould of each mould set, the fluid delivery mechanism being substantially stationary relative to the series of mould sets;
wherein each mould set is configured to cut off a leading portion of a lollipop material strand when moved from the open position to the closed position;
wherein each mould set is configured to mould the lollipop material into a lollipop head when in the closed position; and
wherein each mould set is configured to receive the lollipop material when in the open position.

23. The device of claim 22, wherein the treated surface comprises at least a part of the inner surfaces of both the upper mould and the lower mould of each mould set.

24. The device of claim 23, wherein the fluid delivery mechanism is positioned between the local movement paths of the upper mould and the lower mould of each mould set.

25. The device of claim 22, wherein the treated surface comprises at least a part of an outer surface of each mould set.

26. The device of claim 22, wherein the fluid delivery mechanism comprises a spraying mechanism for delivering a pressurized liquid.

27. The device of claim 26, further comprising:
a heating mechanism for heating the pressurized liquid.

28. The device of claim 26, wherein each lower mould is arranged on a circulating carrier and each upper mould is hinged to a lower mould by a hinge for movement between the closed position and the open position; and wherein the spraying mechanism is positioned for delivering one or more jets of the pressurized fluid to the outside surfaces of each upper mould.

29. The device of claim 28, wherein the spraying mechanism is positioned in a track of the circulation of the mould sets where the mould sets are closed.

30. The device of claim 26, wherein each lower mould is arranged on a circulating carrier and each upper mould is hinged to a lower mould by a hinge for movement between the open position and the closed position, and wherein the spraying mechanism is positioned for delivering one or more jets of the pressurized fluid to the inside surface of each upper mould and/or the inside surface of each lower mould.

31. The device of claim 30, wherein the spraying mechanism is positioned in a track of the circulation of the mould sets where the mould sets are open.

32. The device of claim 22, wherein the fluid delivery mechanism comprises a spraying mechanism for delivering a pressurized gas.

33. The device of claim 32, wherein each lower mould is arranged on a circulating carrier and each upper mould is hinged to a lower mould for movement between the open position and the closed position, and wherein the spraying mechanism is positioned for delivering one or more jets of the pressurized gas to the hinges.

34. The device of claim 33, wherein the spraying mechanism is positioned in a track of the circulation of the mould sets where the mould sets are closed and/or where the mould sets start to move from the closed position to the open position.

35. The device of claim 32, wherein the spaying mechanism is positioned for delivering one or more jets of the pressurized gas to the inside surface of each upper mould and/or the inside surface of each lower mould.

36. The device of claim 35, wherein the spraying mechanism is positioned in a track of the circulation of the mould sets where the mould sets are open.

37. The device of claim 22, wherein the fluid delivery mechanism comprises a spraying mechanism for delivering a lubricant.

38. The device of claim 37, wherein each lower mould is arranged on a circulating carrier and each upper mould is hinged to a lower mould by a hinge for movement between the open position and the closed position, and wherein the spraying mechanism is positioned for delivering the lubricant to the hinges.

39. The device of claim 37, wherein each mould set further comprises a mould stamp, the mould stamp being arranged on a stamp rod that is movable between an inactive position and a pressing position; and
wherein the stamp rod is guided in a guide, wherein the spraying mechanism is positioned for delivering the lubricant to the stamp rod and/or the guide.

40. The device of claim 39, wherein the spraying mechanism is positioned so that the stamp rod is situated at least close to the inactive position.

41. The device of claim 22, further comprising:
a drum drive;
wherein the series of mould sets are arranged on the drum drive so as to circulate about the horizontal axis of rotation.

42. The device of claim 22, further comprising:
a setting mechanism for setting an active time of the fluid delivery mechanism.

43. A device for manufacturing candy, comprising:
a series of mould sets configured to circulate, each mould set comprising a lower mould and an upper mould that are mutually moveable between a closed position wherein the mould set is closed and the upper mould abuts the lower mould, and an open position wherein the mould set is open; and
fluid delivery means for delivering one or more pressurized jets of fluid to a treated surface, the treated surface comprising at least a portion of the surfaces of both the upper mould and the lower mould of each mould set, the fluid delivery means being substantially stationary relative to the series of mould sets;
wherein each mould set is configured to cut off a leading portion of a lollipop material strand when moved from the open position to the closed position;
wherein each mould set is configured to mould the lollipop material into a lollipop head when in the closed position; and
wherein each mould set is configured to receive the lollipop material when in the open position.
